(19) United States
(12) Patent Application Publication
(10) Pub. No.: US 2022/0308894 A1
(43) Pub. Date: Sep. 29, 2022

(54) PERIPHERAL DEVICE SETTING CONFIGURATION

(71) Applicant: Hewlett-Packard Development Company, L.P., Spring, TX (US)

(72) Inventors: Thomas da Silva Paula, Porto Alegre (BR); Alexandre Santos da Silva, Jr., Porto Alegre (BR); Wagston Tassoni Staehler, Porto Alegre (BR)

(73) Assignee: Hewlett-Packard Development Company, L.P., Spring, TX (US)

(21) Appl. No.: 17/641,641

(22) PCT Filed: Oct. 15, 2019
(86) PCT No.: PCT/US2019/056322

§ 371 Date: Mar. 9, 2022

(51) Int. Cl. G06F 9/4401; G06F 13/10

(52) U.S. Cl. CPC G06F 9/4415; G06F 13/102

(57) ABSTRACT

An application-classification and peripheral device settings (APDS) system may comprise a categorization subsystem to capture descriptive information about an application, analyze the descriptive information, determine a classification of the application, and assign the application to an application category that includes applications that each have a similar classification. The system may also include a peripheral device configuration subsystem to identify a peripheral device setting from the application category and apply the peripheral device setting to an operating configuration of the application.

### BACKGROUND

Computing devices, such as desktop and laptop computers, may be used to execute different applications at different times. Peripheral devices connected to the computing devices may be used in conjunction with the different applications. For example, a user may use a mouse and keyboard as input devices to operate each different application. A user may also modify settings of peripheral devices based on the application currently in use. For example, the user can select a first color of backlighting (e.g., white) on a keyboard when using a word processing application and then manually select a different color (e.g., red) of backlighting when playing a gaming application. To personalize or adjust settings of the peripheral devices, the user may manually change the configuration of the peripheral devices each time the user begins using a different application (i.e., switches between applications).

### BRIEF DESCRIPTION OF THE DRAWINGS

Non-limiting and non-exhaustive examples of the disclosure are described in conjunction with the figures described below.

FIG. 1A illustrates an example of a computing system that includes a computer in communication with various peripheral devices.

FIG. 1B illustrates a block diagram of application descriptions being preprocessed, clustered, and categorized.

FIG. 2A illustrates an example of a computing system executing a multiplayer online battle arena (MOBA) game application.

FIG. 2B illustrates an example of the computing system executing an image editing application.

FIG. 3 illustrates an example of a computing system executing an electronic game application in a room.

FIG. 4 illustrates an example block diagram of a computing system for configuring peripheral device settings of an application.

FIG. 5 illustrates a flowchart of an example process for configuring a peripheral device setting of an application.

FIG. 6 illustrates a flowchart of a system applying peripheral device settings to previously categorized applications and categorizing uncategorized applications.

### DETAILED DESCRIPTION

A user may utilize a computing system to execute word processing applications, spreadsheet applications, graphics editing applications, presentation development applications, e-mail messaging applications, web browsing applications, etc. A user may also utilize a computing system as part of an entertainment system to execute electronic gaming applications and play audio/video material (e.g., movies and television programs). Peripheral devices, including input/output (I/O) devices, may communicate with computing systems. Examples of peripheral devices include mouses, keyboards, speakers, computer monitors, controllers, microphones, and other ancillary devices used to input information into and/or output information from a computing system. Additional examples of peripheral devices include appliances such as, for example, lights, video displays, and/or other devices connected to the computing system and used in conjunction with the executed applications.

Adjustable sensory devices or systems coupled to peripheral devices may enhance user experiences. For example, a monitor, a keyboard, a mouse, and/or speakers connected to a computing system may include lighting systems such as red, green, blue (RGB) lighting controls with adjustable operating configurations. As described herein, an application-classification and peripheral device settings (APDS) system may automatically detect the application being executed (i.e., the active application) and dynamically adjust peripheral device settings. The APDS system may adjust the peripheral device settings based on, for example, a detected type or category of application. For instance, the APDS system may adjust the color, the illumination or brightness, and/or the arrangement or mapping of the lights on a monitor, a keyboard, a mouse, and/or speakers based on the category of the active application on the computing system.

The present disclosure generally relates to systems and methods for leveraging knowledge and experience regarding computer applications and determining operating configurations of peripheral device settings for similar computer applications. According to various examples, the APDS system may track an application and the system may collect information describing the application. For instance, the APDS system may obtain and store application metadata that may include a type of the application, application settings, descriptions about components of the application, specific tags, user interactions with the application, or other information describing the application. After storing the application and the respective metadata, the APDS system may classify the metadata and the system may categorize the application according to the classification(s) and/or preprocessing of such metadata.

Over time, the APDS system may categorize any number of applications into any number of categories. Some categories may have only a single application, while other categories may include multiple applications. Each category may define a set of peripheral device settings for any number of peripheral devices associated with applications in the specific category. For example, a first category may define a first keyboard backlight color (or color pattern) along with mouse settings, such as tracking speed, double-click speed, cursor size, cursor shape, etc. A second category of applications may define a second, different keyboard backlight color (or color pattern) and a faster mouse tracking speed.

When the APDS system detects that the computer has launched (or made active) a new application, the APDS system may collect information about the new application. If the APDS system determines that the new application falls within an existing category, the APDS system may automatically set the peripheral device settings of the computer to match those defined within the existing category. Otherwise, a new category may be created with new peripheral device settings defined therein. In some examples, the new peripheral device settings may initially be set to default settings and then updated or modified to match settings manually selected by a user during execution of the new application.

For example, if the newly launched (active) application matches a first category of applications, the APDS system may automatically set a keyboard illumination setting, a keyboard shortcut mapping, a backlight setting, a sensitivity setting, and a mouse illumination setting as defined by the first category of applications. As such, the APDS system may provide users with a personalized computing environment based on the application currently being executed by an underlying computing system (or made active when multiple applications are being executed) without the user having to manually configure the settings for the peripheral devices.

As described herein, the APDS may be implemented in hardware, firmware, as computer-readable instructions executable by a processor of a computing system, and/or combinations thereof. In various examples, the APDS may comprise various modules or subsystems operable to implement one or more functions of the APDS. Each module or subsystem may be implemented as hardware, firmware, computer-executable instructions, and/or a combination thereof.

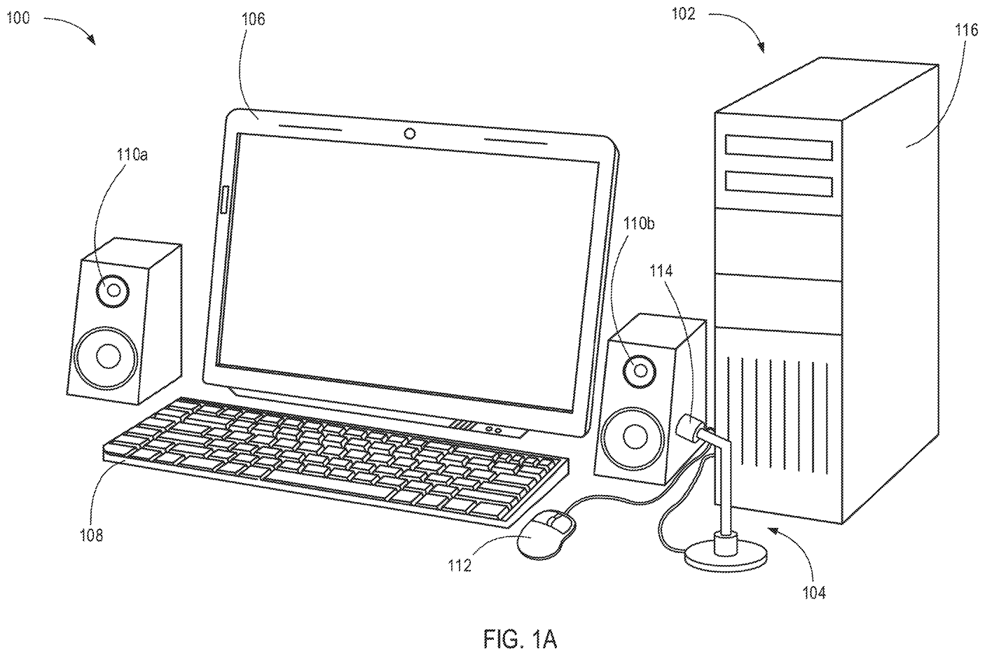

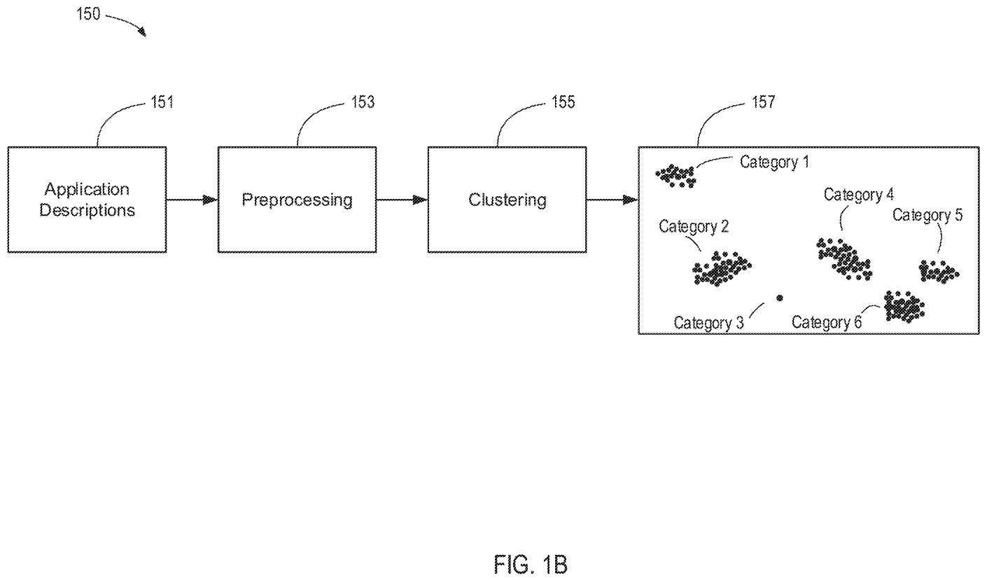

FIG. 1A illustrates an example of a computing system 100 that includes a computer 102 in communication with various peripheral devices 104. In this example, the peripheral devices 104 include a monitor 106, a keyboard 108, speakers 110a and 110b, a mouse 112, a microphone 114, and a housing 116. In some cases, the peripheral devices 104 may include sensory devices such as auditory devices, visual devices, and/or tactile devices. For instance, the keyboard 108 may include lights that illuminate the keys on the keyboard 108. The peripheral devices 104 may operate according to peripheral device settings selectable on the computer 102.

When the computer 102 executes an application, the presently described systems and methods may automatically detect a category of the application and dynamically and automatically modify peripheral device settings of the peripheral devices 104. The peripheral device settings may, for example, define the colors of the lights, the illumination/brightness of the lights, the arrangement/mapping of the lights, the sensitivity of the keys on the keyboard 108, the responsiveness of the mouse 112, and/or display settings of the monitor 106. The peripheral device settings associated with the identified application category may also define a volume level, equalizer settings, and/or settings of the speakers 110a and 110b.

FIG. 1B illustrates a block diagram 150 of application descriptions being preprocessed, clustered, and categorized. As illustrated, an APDS system receives application descriptions 151 and preprocesses 153 the descriptions. For example, when the application descriptions 151 comprise text, a categorization subsystem may perform textual analysis, word processing, and/or key word detection.

The preprocessed 153 application descriptions 151 may then be clustered 155 and categorized into various categories 157 based on the textual analysis of the textual descriptions of the applications 151. As one example, categories 157 of applications may be based on keywords and/or phrases. For example, applications related to word processing may be categorized as word processing applications while applications that include keywords or key phrases like “photo editing” may fall into a different category 157. As described herein, each category of application may be associated with a set of peripheral device settings. Accordingly, when the computer executes an application, the APDS system may determine the category of the application being executed and modify peripheral device settings to match those in the identified application category.

In some examples, a computing system, such as a laptop or desktop computing system, may have a plurality of applications installed thereon. For example, the computing system may include any number of web browser applications, gaming applications, document creating and editing applications, photo editing applications, video editing applications, music player applications, video player applications, emailing applications, mapping applications, and other types of applications.

Each application may include accessible metadata describing the application type. For instances, universally accepted or standardized application categories may be developed and utilized by application creators to aid in the categorization of applications. In other examples, applications within application management platforms, such as the Apple App Store® and the Microsoft Store®, include various application categories and sub-categories within which applications are already categorized. In some examples, the APDS system may utilize these existing application categories and sub-categories to cluster and/or categorize applications installed on the computing system.

In other examples, the applications may not have any universally accepted or standardized metadata descriptions nor be pre-categorized within existing application management platforms. Instead, each application may include a plain-text description of the functionality of the application that is stored on the computing system or available on a website associated with the applications. For example, iTunes® is described online as “the easiest way to enjoy everything you need to be entertained—music, movies, and TV shows.” Word® is described as being “ . . . the desktop application built for the creation of polished documents.” Minecraft® is described as an “action & adventure” game and Age of Empires® is described as a “real-time strategy” game.

The APDS system may analyze the available plain text descriptions of each application installed on a computing device and categorize and/or cluster them based on keywords and/or phrases. For example, the APDS system may cluster all applications that contain combinations of the words “documents,” “presentations,” “slides,” “creation,” and “editing” within one category while applications that contain combinations of the words “game,” “strategy,” “combat,” and “adventure,” may be clustered within a second category. The APDS system may be manually configured with words and or phrases associated with each application category. The APDS system may identify matching words and/or phrases within a description associated with an application and thereby categorize the application.

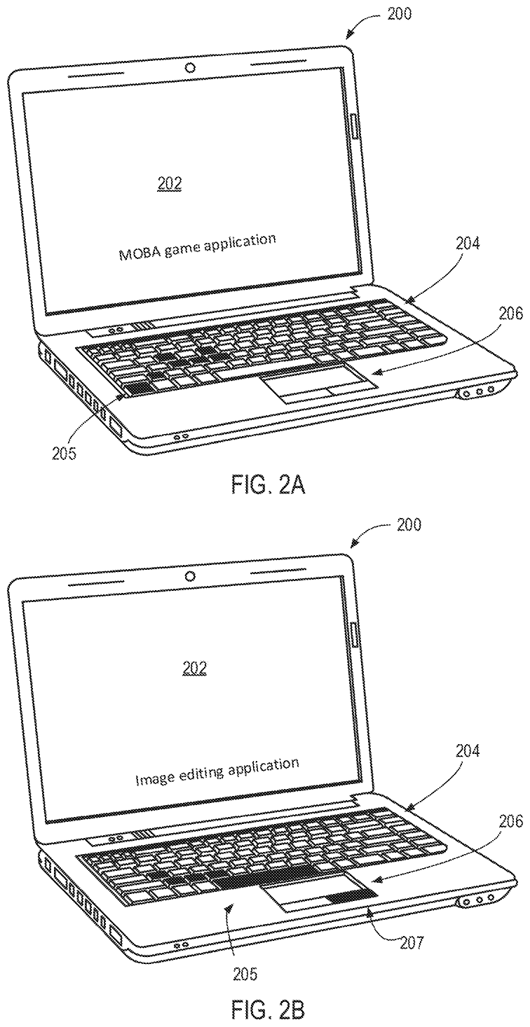

FIG. 2A illustrates an example of a computing system 200 executing a multiplayer online battle arena (MOBA) game application. In this example, the computing system 200 is a laptop computing device and comprises integrated peripheral devices, including an electronic display 202 (i.e., a monitor), a keyboard 204, and a trackpad mouse 206. In this example, the keyboard 204 includes configurable backlit keys. The computing system 200 includes an integrated APDS system implemented in hardware, firmware, and/or computer-readable instructions executable by a processor of the computing system 200.

The APDS system may detect that the computing system 200 is executing the MOBA game application. A categorization subsystem may analyze descriptive information associated with the MOBA game application and assign the MOBA game application to a “gaming” category of applications. The APDS system may illuminate the keys 205 (shown as black keys) a different color and/or brightness than the other keys (shown as white keys) on the keyboard 204. These keys may, for example, be keys that were previously detected as being used with a higher frequency than other keys during the execution of other applications previously categorized within the “gaming” category.

In some examples, the APDS system may apply additional peripheral device settings to the computing system 200 associated with the “gaming” category. For example, the APDS system may temporarily enable a specific keyboard shortcut mapping in which specific key combinations are mapped to specific functions within the gaming applications categorized within the “gaming” category. Similarly, the APDS system may modify keyboard responsiveness and/or trackpad sensitivity settings. The computing system 200 may default to allow for the trackpad to be used simultaneously with an external mouse (e.g., a USB or Bluetooth mouse). However, the peripheral device settings for the “gaming” category may dictate that the trackpad 206 is disabled in favor of only the external mouse during gameplay to avoid accidental trackpad contact during gameplay.

In various examples, the user may set and/or the APDS system may automatically detect any combination of peripheral device settings and associate them with the “gaming” category. Anytime an application is executed that the APDS system categorizes within the “gaming” category, the APDS system automatically applies the saved peripheral device settings to the computing system 200.

FIG. 2B illustrates an example of a computing system 200 executing an image editing application. The APDS system identifies the image editing application as falling within a “utility” category of applications and automatically adjusts the peripheral device settings to match those associated with the detected category. As illustrated, a different set of keys 205 (shown in black) may be backlit on the keyboard 204 with a different color to visually distinguish them from the other keys (shown in white) on the keyboard 204.

The APDS system may have previously detected heavy usage of right-clicks on the trackpad 206 (as compared to applications in other categories) and so associated a peripheral device setting with an illuminated trackpad button 207 with the “utility” application category. In some examples, the APDS system may track or capture user interactions with the peripheral devices during the execution of the image editing application and/or manual modifications to the peripheral devices made by the user during the execution of the image editing application. The APDS system may update the peripheral device settings associated with the “utility” application category based on the captured user interactions.

In some instances, a user may decline the peripheral device settings applied by the APDS system to the operating configurations of the peripheral devices. The APDS system may recategorize the application and capture user interactions during execution of the application to define a new application category and associate new peripheral device settings with the new application category based on the captured user interactions. The APDS system may also include a default state for the peripheral devices. Once an application within an application category is closed, the APDS system may automatically apply the default peripheral device settings to the operating configuration of the various peripheral devices.

In some examples, the peripheral device settings associated with each application category and/or the various application categories may be stored within a cloud computing environment. In such examples, the APDS system may detect the execution of an application and query the cloud-based system to identify a category for the application and/or various peripheral device settings associated therewith.

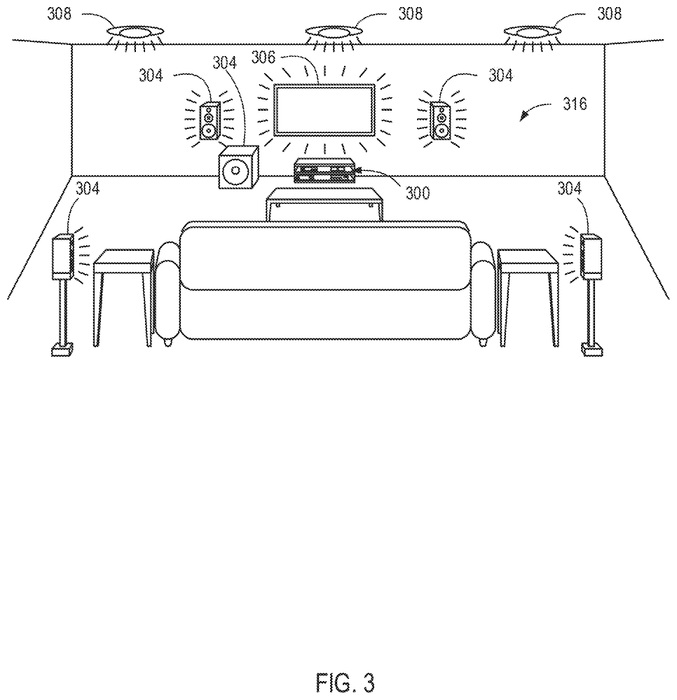

FIG. 3 illustrates an example of an APDS system 300 integrated into a computing system that is part of a multimedia room 316. The APDS system 300 may detect that the computing system is currently executing an electronic game application in the room 316. The APDS system 300 may identify peripheral device settings associated with an “electronic game” category of applications and apply these peripheral device settings to the operation configurations of the various peripheral devices. For example, the APDS system 300 may implement a gaming-specific equalization and volume level to be implemented by the speakers 304 and adjust the light levels of connected ceiling lights 308. The APDS system 300 may adjust a color, brightness, saturation, contrast, black level, and/or other display setting of the electronic display 306.

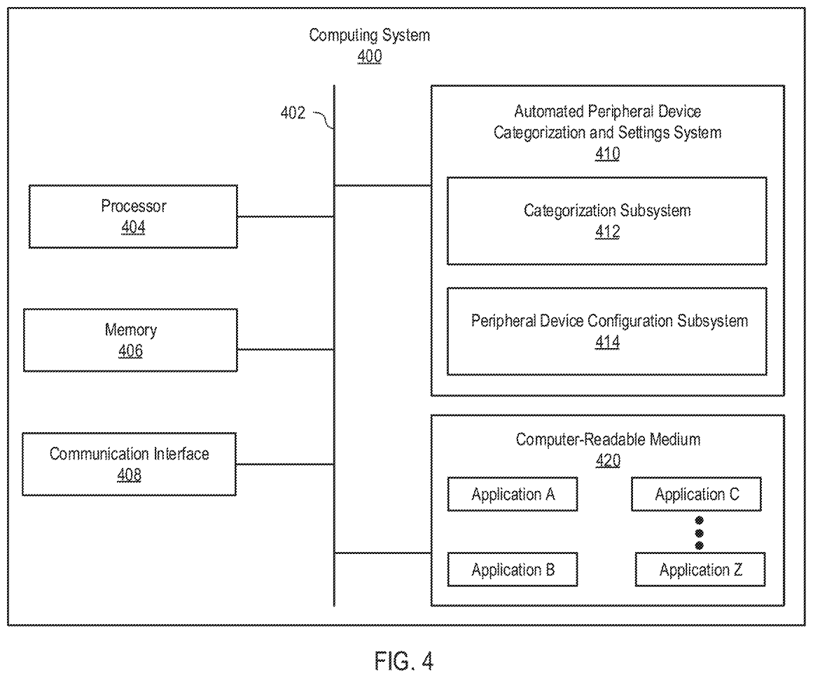

FIG. 4 illustrates an example block diagram of a computing system 400 that includes an APDS system to categorize and configure peripheral device settings. As illustrated, the computing system 400 includes a bus 402 connecting a processor 404 (e.g., microprocessor, field programmable gate array (FPGA), microcontroller, etc.), a memory 406, and a communication interface 408 to the APDS system 410. The APDS system 410 may be implemented as hardware or firmware within the computing system 400. In other examples, the APDS system 410 may be implemented as instructions within a non-transitory computer-readable medium to be executed by the processor 404. The communication interface 408 may connect the computing system 400 to any of a wide variety of peripheral devices for inputting and/or outputting information to and from the computing system 400.

The bus 402 may also connect the processor 404 and memory 406 to a computer-readable medium 420 storing instructions for executing any number of applications (illustrated as Applications A-Z) within any number of application categories. For example, the computing system 400 may include a computer-readable medium 420 that stores instructions for word processing applications, photo editing applications, gaming applications, utility applications, web browsers, etc. Other types of applications available to be executed by the computing system 400 are innumerable and are known in the art.

As shown, the APDS system 410 may include a categorization subsystem 412 and a peripheral device configuration subsystem 414. The categorization subsystem 412 may capture description information about each application within the computer-readable medium 420 and determine a classification of each application based on an analysis of the descriptive information. The categorization subsystem 412 may assign each application to an application category, where each application category comprises a subset of the applications that have similar classifications. For example, all of the applications related to web browsing may be categorized within a “web browsing” category, all of the applications that relate to programming may be categorized within a “coding” category, all of the applications that relate to gaming may be categorized with a “gaming” category. The number and type of categories may be automatically defined by the APDS system 410 and/or manually assigned by the user.

The categorization subsystem 412 may utilize descriptive information about each application that may be in the form of application metadata, online descriptions of the applications, descriptions about components of the application, specific tags, historic user interactions with the application, and the like. In some examples, the descriptive information may be provided by the creator of the application and stored on the computing system with the application itself (e.g., as a plain text description or as computer-readable metadata. In other examples, the application may be described and/or even partially categorized on an application management platform. In still other examples, the categorization subsystem 412 may look online for a description of the application via a search engine or a website associated with the specific application being categorized. When the descriptive information includes a text description, the categorization subsystem 412 may analyze the descriptive information using standard natural language processing techniques such as removing punctuation and stop words from the text.

Additionally, the categorization subsystem 412 may apply sentence embedding techniques such as, for example, FastText to obtain classification criteria. The categorization subsystem 412 may assign the application to an application category that includes a set of applications that have a similar classification(s). In some examples, the categorization subsystem 412 may use the classification criteria as input to a clustering algorithm such as a K-means clustering-based algorithm to assign each application to an application category.

When the APDS system 410 detects an application from the computer-readable medium 420 being executed by computing system 400, the peripheral device configuration subsystem 414 identifies peripheral device settings from the application category to which the application being executed is assigned. The peripheral device configuration subsystem 414 applies each of the identified peripheral device settings to each of the respective peripheral devices connected to the computing system 400.

As described herein, the peripheral devices to which the peripheral device settings may be applied may include, for example, a mouse, a keyboard, speakers, computer monitors (i.e., electronic displays), controllers, microphones, and/or other ancillary devices integrated into the computing system 400. In some examples, peripheral devices may also include lights, sound systems, video displays, and other devices in communication with the computing system 400.

In some examples, the peripheral device configuration subsystem 414 may capture user interactions with peripheral devices during execution of an application and then modify the peripheral device settings associated with the application category to which the application is assigned.

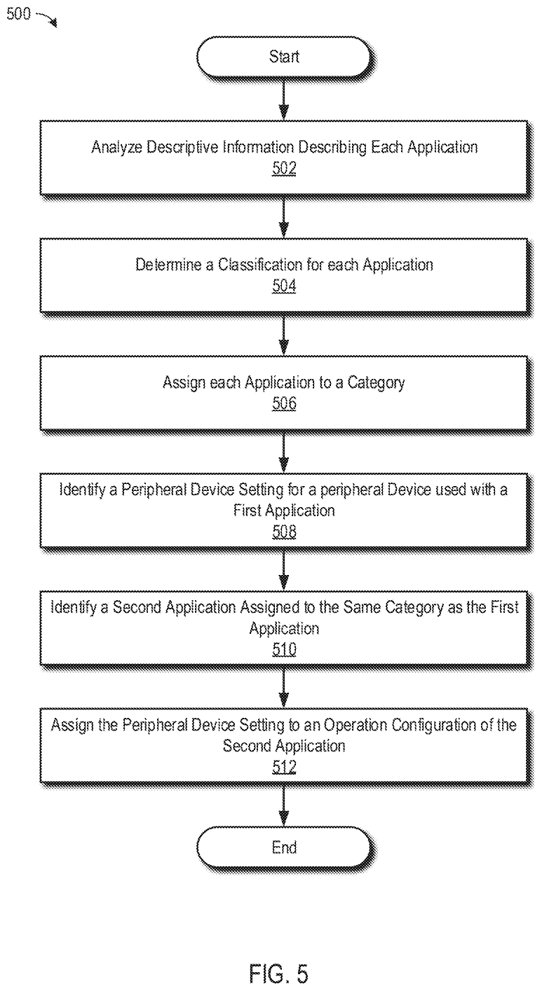

FIG. 5 illustrates a flowchart 500 of an example process for configuring a peripheral device setting of an application. At 502, a system may analyze descriptive information describing each application. At 504, the system may determine a classification for each application based on the analysis of the descriptive information. At 506, the system may assign each application to a category based on their classification. At 508, the system may identify a first peripheral device setting for a first peripheral device used with a first application.

At 510, the system may identify a second application that is assigned to the same category as the first application. At 512, the system may assign the first peripheral device setting to an operating configuration of the second application. In some examples, the system may further capture user interactions with the first peripheral device during execution of the first application and modify the first peripheral device setting based on the captured user interactions.

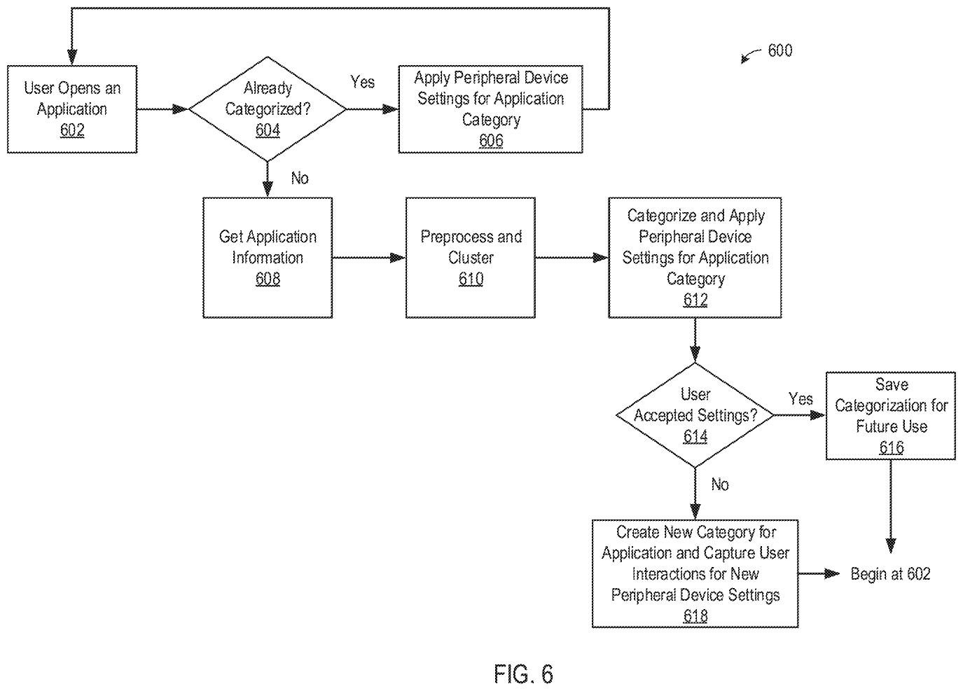

FIG. 6 illustrates a flowchart 600 of an APDS system applying peripheral device settings for previously categorized applications and categorizing uncategorized applications. At 602, a user opens an application. If the application has already been categorized, at 604, then the APDS system applies, at 606, peripheral device settings assigned to the application category to the operations configuration of the peripheral devices. If the application has not previously been categorized, at 604, then the APDS system retrieves application information, at 608, such as descriptions of the application, metadata associated with the application, and/or historical usage data. The APDS system preprocesses, classifies, and/or clusters, at 610, the application. The APDS system categorizes, at 612, the application based the descriptive information and applies the peripheral device settings associated with the application category to which the application is assigned.

In some examples, the user may accept the applied peripheral device settings, at 614, and the application categorization and associated peripheral device settings may be saved for future use, at 616. In other instances, the user may reject, at 614, the peripheral device settings and begin using the application with default peripheral device settings and/or manually configured peripheral device settings. The APDS may capture, at 618, the manually configured peripheral device settings and/or capture user interactions with the various peripheral devices. The captured peripheral device settings may be stored and associated with a new application category to which the application is assigned. In other instances, the captured peripheral device settings may match those of another application category and the APDS system may recategorize the application into the matching category for future reference.

While specific examples and applications of the disclosure have been illustrated and described, it is understood that the disclosure is not limited to the precise configurations and components disclosed herein. Accordingly, many changes may be made to the details of the above-described examples without departing from the underlying principles of this disclosure consistent with the following claims.

What is claimed is:

1. A system comprising:
a categorization subsystem to:
capture descriptive information about an application;
analyze the descriptive information;
determine a classification of the application based on the analysis of the descriptive information; and
assign the application to an application category that includes a set of applications that each have a similar classification as the classification of the application; and
a peripheral device configuration subsystem to:
identify a peripheral device setting from the application category; and
apply the peripheral device setting to an operating configuration of the application.

2. The system of claim 1, wherein the peripheral device configuration subsystem is further to:
capture a user interaction with a peripheral device during execution of the first application; and
update the peripheral device setting for the application category based on the captured user interaction.

3. The system of claim 1, wherein the peripheral device setting comprises at least one of: a keyboard illumination setting, a keyboard shortcut mapping, a backlight setting, a sensitivity setting, and a mouse illumination setting.

4. The system of claim 1, wherein the categorization subsystem utilizes data from a cloud computing environment to assign the application to the application category.

5. The system of claim 1, wherein the categorization subsystem utilizes data from a local computing database to assign the application to the application category.

6. A system comprising:
a categorization subsystem to:
analyze descriptive information associated with each application of a set of applications; and
assign each application of the set of applications to one of a plurality of categories based on the analysis of the descriptive information of each respective application; and
a peripheral device configuration subsystem to:
identify a first peripheral device setting for a first peripheral device used with a first application of the set of applications;
identify a second application of the set of applications that is assigned to the same category as the first application; and
apply the first peripheral device setting to an operating configuration of the second application.

7. The system of claim 6, wherein the peripheral device configuration subsystem is further to:
capture a user interaction with the first peripheral device during execution of the first application; and
modify the first peripheral device setting based on the user interaction.

8. The system of claim 6, wherein the peripheral device configuration subsystem is further to:
identify a plurality of peripheral device settings for each of a plurality of peripheral devices used with the first application; and
apply each of the plurality of peripheral device settings to operating configurations of each other application assigned to the same category of the first application.

9. The system of claim 6, wherein the categorization subsystem is further to store each of the assigned categories in at least one of a cloud computing environment and a local computing database.

10. The system of claim 6, wherein the first peripheral device setting comprises a keyboard illumination setting.

11. The system of claim 6, wherein the categorization subsystem analyzes the descriptive information via at least one of standard natural language processing and metadata processing.

12. A non-transitory computer-readable medium with instructions stored thereon that, when implemented by a processor, cause the processor to perform operations to:
analyze descriptive information describing each application in a set of applications;
determine a classification for each application of the set of applications based on the analysis of the descriptive information;
assign each application of the set of applications to a category based on each respective classification;
identify a first peripheral device setting for a first peripheral device used with a first application of the set of applications;
identify a second application of the set of applications that is assigned to the same category as the first application; and
apply the first peripheral device setting to an operating configuration of the second application.

13. The non-transitory computer-readable medium of claim 12, wherein the operations further comprise:
capture a user interaction with the first peripheral device during execution of the first application; and
modify the first peripheral device setting based on the user interaction.

14. The non-transitory computer-readable medium of claim 12, wherein the peripheral device setting comprises a keyboard illumination setting.

15. The non-transitory computer-readable medium of claim 12, wherein the peripheral device setting comprises a mouse illumination setting.
